(19) United States
(12) Patent Application Publication
(10) Pub. No.: US 2004/0203872 A1
(43) Pub. Date: Oct. 14, 2004

(54) Wireless network location estimation

(76) Inventor: Sundeep M. Bajikar, Mountain View, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/235,612

(22) Filed: Sep. 4, 2002

(51) Int. Cl. H04Q 7/20

(52) U.S. Cl. 455/456.1; 455/67.11

(57) ABSTRACT

The determination of the physical location of a device and, more particularly, to the determination of the physical location of a mobile client device operating on a wireless local area network (WLAN).

### BACKGROUND

1. Field

The disclosed subject matter relates to the determination of the physical location of a device and, more particularly, to the determination of the physical location of a mobile client device operating on a wireless local area network (WLAN).

2. Background Information

Currently, if a user wishes to use a location specific feature of a mobile client device, they would normally determine the location of the device from an exterior source, and then input that information into the device. Such an exterior source may be, for example, a device that accesses the global positioning system (GPS) or a paper map. This process often involves multiple devices and is frequently considered cumbersome and inconvenient.

It is possible to integrate a device that may access the global positioning system (GPS) with a wireless mobile client device. However, the addition of this GPS device is often expensive and serves only one purpose, the detection of the mobile client device's location. In addition, GPS is primarily an outdoor positioning system and does not work well indoors, which is where wireless mobile client devices are frequently used. Furthermore, even if GPS is utilized, in order to derive a reliable human-scale indoor positioning, an augmentation technology should be employed. A need, therefore, exists for an improved system or technique for determining the physical location of a wireless mobile client device that is neither inconvenient nor expensive.

### BRIEF DESCRIPTION OF THE DRAWINGS

Subject matter is particularly pointed out and distinctly claimed in the concluding portions of the specification. The disclosed subject matter, however, both as to organization and the method of operation, together with objects, features and advantages thereof, may be best understood by a reference to the following detailed description when read with the accompanying drawings in which:

FIG. 1 is a flowchart diagram illustrating an embodiment of a technique for the determination of the physical location of a wireless local area network (WLAN) mobile client device in accordance with the disclosed subject matter;

FIG. 2 is a block diagram illustrating an embodiment of a system for the determination of the physical location of a wireless local area network (WLAN) mobile client device in accordance with the disclosed subject matter; and

FIG. 3 is a block diagram illustrating an embodiment of a system for the determination of the physical location of a wireless local area network (WLAN) mobile client device in accordance with the disclosed subject matter.

### DETAILED DESCRIPTION

In the following detailed description, numerous details are set forth in order to provide a thorough understanding of the present disclosed subject matter. However, it will be understood that the disclosed subject matter may be practiced without these specific details. In other instances, well-known methods, procedures, components, and circuits have not been described in detail so as to not obscure the disclosed subject matter.

In this context, a “wireless local area network (WLAN)” is a group of computers or other devices dispersed over a relatively limited area and connected by a wireless communications link or protocol that enables any device to interact with any other device on the network. WLANs may include, for example, computers and shared resources such as laser printers and computer peripherals, such as a mouse. The devices on a WLAN may be referred to as nodes. Such a wireless protocol may involve technologies, such as, for example, radio frequency communication or infrared frequency communication. However, it is contemplated that other wireless technologies utilizing communication via other frequencies may be utilized.

In this context, a “wireless local area network (WLAN) mobile client device” or “mobile client device” is a node on a WLAN that may be physically moved with some ease from location to location and is operated by an end user. One of the functions of such a device may be to access other devices via the WLAN. A WLAN mobile client device may include devices, such as, for example, a laptop computer, a handheld computer, a personal digital assistant, a wireless local area network (WLAN) interface card, and a computer peripheral, such as, for example, a printer or mouse. However, these are merely a few non-limiting examples of such a device.

In this context, a “wireless local area network (WLAN) access point” or “access point” is a node on a WLAN that is semi-permanently located in a fixed place and provides access to a network. Examples of such a network may include networks, such as, for example, the Internet or an intranet. Although the illustrated embodiments of the disclosed subject matter deal mainly with access to the Internet, it is contemplated that various embodiments may be easily adapted to interface with a variety of networks and that the disclosed subject matter is not limited to any particular network. It is contemplated that an access point may not be directly coupled to a network backbone; an access point may merely serve as a gateway to another network, which in turn provides access to a network backbone.

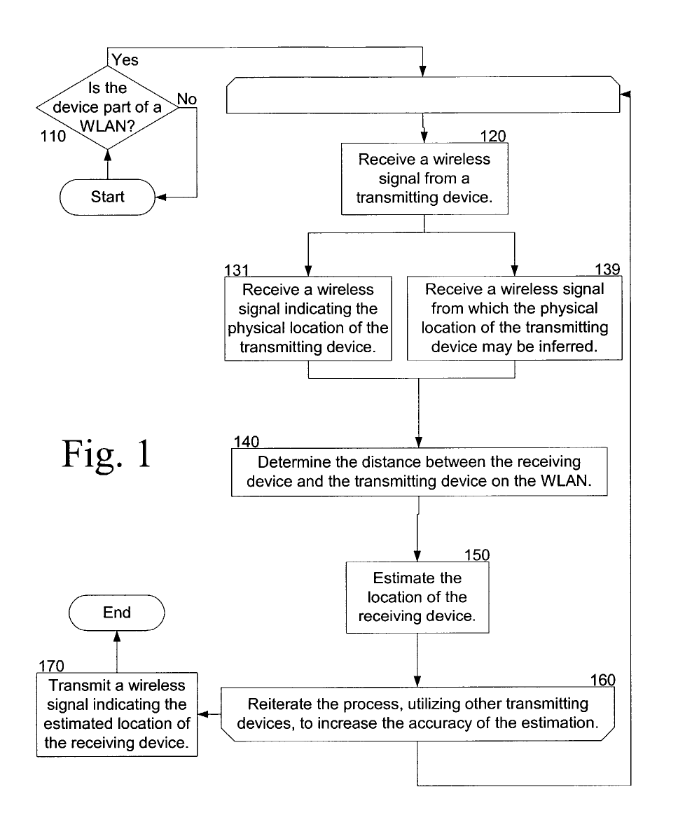

FIG. 1 is a flowchart diagram illustrating an embodiment of the disclosed subject matter. Such a technique may be used to estimate the physical location of a WLAN mobile client device. Block 110 illustrates that a WLAN mobile client device may be established as part of a WLAN. In a specific example, a laptop computer may establish itself to operate on a WLAN within an office environment.

In the specific example above, the laptop computer may utilize a WLAN protocol, which is substantially in compliance with, for example, the IEEE 802.11b wireless local area network (WLAN) standard. Supplement to 802.11-1999, Wireless LAN MAC and PHY specifications: Higher speed Physical Layer (PHY) extension in the 2.4 GHz band, IEEE Std. 802.11b-1999 (hereafter “802.11b”). In another embodiment of this specific example, the laptop may utilize a protocol, which is substantially in compliance with, for example, any standard derived from or supplemental to the IEEE 802.11 wireless local area network (WLAN) standard (hereafter, “the 802.11 standard or specification family”). Standards for Information Technology—Telecommunications and Information Exchange between Systems—Local and Metropolitan Area Network—Specific Requirements—Part 11: Wireless LAN Medium Access Control (MAC) and Physical Layer (PHY) Specifications, ANSI/IEEE Std. 802.11-1999 (hereafter “802.11”).

It is contemplated that these are merely a few specific examples of wireless protocols and that a variety of protocols may be used, such as for example, a protocol which utilizes frequencies in the infrared spectrum, a protocol which utilizes frequencies in the radio spectrum, or, in yet another example, a protocol substantially in compliance with the Bluetooth wireless specification. Specification of the Bluetooth System, Bluetooth SIG ver. 1.1, Feb. 22, 2001 (hereafter, “Bluetooth”). It is contemplated that these are merely a few non-limiting examples and other communication protocols may also be used.

Block 120 illustrates that the mobile client device may receive a wireless signal from a transmitting device. It is contemplated that this signal may be received as part of the normal communication between the mobile client device and other nodes of the WLAN, or, in one of many alternative embodiments, the signal may be received as a result of a special request from the mobile client device. The transmitting device may be a device, such as, for example, another mobile client device or a wireless local area network (WLAN) access point. However, these are merely a few non-limiting examples.

An embodiment of the specific example above, the laptop may receive a wireless signal from a WLAN access point as part of becoming established on the network. In this specific example, the WLAN access point may be, for example, physically mounted with the ceiling of the office environment. It is contemplated that such an access point may be located in a variety of places and that the disclosed subject matter is not limited to any one location.

Block 131 illustrates that the mobile client device may receive a wireless signal indicating the physical location of the transmitting device. It is contemplated that this wireless signal may be the same signal as received in block 120. To continue the specific example above, the access point may transmit its physical location to the laptop computer. It is contemplated that the access point may know its physical location through a variety of techniques, such as, for example, the location may be statically configured into the access point by the installer or maintainer of the access point, or, in another embodiment, the access point may dynamically determine its location. Of course, these are merely two possible examples and that other techniques may be used.

Block 140 illustrates that the mobile client device may determine or estimate the distance between the mobile client device and the transmitting device. This may be done by employing a variety of techniques. It is contemplated that the determination need not be completely accurate and that an estimation of the distance within an acceptable degree of tolerance would be appropriate. It is also contemplated that this acceptable degree of tolerance would vary depending on the situation. It is further contemplated that many techniques may be used to perform block 140.

In one embodiment, the mobile client device may determine the device's distance from the transmitting device by utilizing the known range of the WLAN protocol. In a specific example, a laptop may communicate with the access point using a variation of the 802.11 standard. This protocol may have an effective range of, for example, 100 meters. Therefore, as part of block 140, the laptop may be aware that the access point may be less than 100 meters. However, the range of 100 meters is purely an illustrative non-limiting example. It is contemplated that other ranges may be available and that a variety of protocols may be utilized. It is further contemplated that a variety of ranges may utilized based upon the location or environment of the transmitting device. It is even contemplated that the transmitting device may inform the receiving device of the proper range.

In another embodiment, the mobile client device may determine the device's distance from the transmitting device by utilizing an exchange of data. For example, the two devices may exchange a handshake to initiate the distance measurement process. It is contemplated that the successful completion of this initiation may be contingent upon the consent of the transmitting device. The two devices may exchange specialized packets for the purpose of distance measurement signal processing. It is contemplated that these specialized packets may be sent in a synchronous or asynchronous manner. It is contemplated that the synchronization of the packets may be used to minimize the time required to perform the distance measurement. It is further contemplated that the specialized packets may be transmitted by only one of the two devices. It is contemplated that these messages may involve a form of feedback to further refine the distance measurement. It is also contemplated that the mobile client device may communicate with multiple transmitting devices, in order to refine the distance measurement.

It is contemplated that the devices may be able to carry out the action of block 140 utilizing multiple frequencies, such as, for example, 2.4 Gigahertz (GHz) or 5 GHz; however, these are merely two illustrative examples to which the disclosed subject matter is not limited. It is contemplated that the devices may be able to communicate via multiple frequencies simultaneously. Multiple frequencies may be used, for example, to reduce distance measurement errors due to multi-path effects; however, this is merely one possible use if multiple frequencies to which the disclosed subject matter is not limited.

Block 150 illustrates the ability to estimate the location of the mobile client device. The location of the transmitting device and the distance between the transmitting device and receiving device may be used to estimate the location of the receiving device. In a specific example, the laptop may determine that its location is within 100 meters of the location of the access point. However, the range of 100 meters is purely an illustrative non-limiting example. It is contemplated that other ranges may be available and that a variety of protocols may be utilized. It is further contemplated that a variety of ranges may be utilized, based upon the location or environment of the transmitting device. It is even contemplated that the transmitting device may inform the receiving device of the proper range.

In one embodiment, it is contemplated that two or more devices may mutually exchange their locations via a series of messages. For example, a first device may be aware of it location. It is contemplated that this location may be a 2 or 3 dimensional location within a standardized frame of reference, such as, for example, longitude, latitude, and altitude. The first device may communicate with second device. The second device may be unaware of its physical location. The first device may determine that the second device is within 100 meters of the first device; however, the range of 100 meters is purely an illustrative non-limiting example. The first device may transmit both the estimated distance and the physical location of the first device to the second device. This may enable the second device to estimate its physical location. It is contemplated that this process may be repeated utilizing a third device in order to refine the location estimation of the second device. It is further contemplated that a number of devices may be interconnected to derive their location utilizing the distance between each device and a small number of known physical locations. It is contemplated that a series of messages may be utilized to remotely manage the physical locations of the devices, including, for example, the ability to query and/or set the location of the devices.

In a second embodiment, the mobile client device may determine the device's distance from the transmitting device by measuring the attenuation or strength of the wireless signal. For example, if the mobile client device knew, or was made aware of, the strength at which the wireless signal was transmitted, the distance the signal traveled could be determined based upon the received signal strength and the attenuation of the signal per meter traveled. A determination of the amount of attenuation experienced by the wireless signal may be made. It is contemplated that the transmitted signal strength may be known through a variety of means, including, but not limited to, a preset value or transmitted as information via the signal itself.

This attenuation of signal strength may be correlated to the distance of the mobile client device from the transmitting device. It is contemplated that in an urban or indoor environment with many surfaces, such as, for example, the office environment of the specific example, a wireless signal may take many transmission paths and experience a certain amount of refraction and reflection before being received by the mobile client device. These impediments may cause more attenuation to occur in the signal than would ideally occur, if the signal had not encountered these impediments. This may include taking the increased attention resulting from such refraction, reflection, or multiple transmission paths into account when determining the distance between the mobile client device and the transmitting device. It is contemplated that the effects of other impediments and adjustment to attenuation may be taken into account when determining the distance of the mobile client device from the transmitting device.

Another technique, which an embodiment of the disclosed subject matter may employ, but is not limited by, in order to determine the distance between the mobile client device and the transmitting device may utilize flight time of the received wireless signal. In this particular embodiment, the flight time of the received wireless signal may be measured. Flight time may be measured via a variety of means, such as, for example, comparing the signal's time of transmittal to its time of receipt. The time the wireless signal was transmitted from the transmitting device may be a piece of information transmitted via the signal.

In the specific example above, the access point may communicate with the laptop via a WLAN protocol that employs direct-sequence spread spectrum (DSSS) transmission technology. In this example, flight time may be determined by relating the phase changes of the DSSS chipping codes to the time of transmittal and the time of receipt. In an illustrative specific example, Direct Sequence Spread Spectrum may be a type of modulation used by a protocol in compliance with the 802.11b standard. This type of modulation is also used by other protocols, such as, for example, GPS. Each transmitter uses a separate Code Division Multiple Access (CDMA) code to “spread” its transmissions. A receiving device may perform a correlation function to acquire lock on the transmitter's CDMA code. Once a lock is acquired, the phase change in the CDMA code transmitted by the transmitter may be determined at the receiver. This phase change may translate into “time of travel” for the signal between the transmitter and the receiver, which in turn provides the range between the transmitter and receiver. If the receiver can similarly find its range(s) from a plurality of transmitters that know their own locations, then the receiver may be able to solve for its own location through triangulation.

In another version of the specific example above, the access point may communicate with the laptop via a WLAN protocol that employs frequency-hopping spread spectrum (FHSS) transmission technology. In this example, flight time may be determined by using a mathematical transfer function to relate the phase changes of the FHSS frequency changes to the time of transmittal and the time of receipt. In a specific illustrative example, FHSS is a type of modulation that may be used by a protocol substantially in compliance with the 802.11a and/or Bluetooth standards. Sequences of changing frequencies of transmission may be used to “spread” the signal. In this specific example, various signal measurement and processing methods can be used to measure the distance between the transmitter and receiver. One such method may be to use an empirical model that relies on the relationship between phase changes experienced by the transmitted signal based on the frequency of transmission and the distance of the receiver from the transmitter. Such a model may process actual phase and frequency measurements to provide an estimate of the distance between. Of course, these are merely illustrative embodiments and that other techniques may be used.

In one embodiment, once the flight time of the wireless signal is known, it may be correlated to distance. It is contemplated that other techniques to correlate time to distance may be used. Range, flight time and attenuation are not the only techniques that may be used to determine the distance between the mobile client device and the transmitting device. It is contemplated that many such techniques are possible and that the actions illustrated by block 140 are merely a few non-limiting examples. It is further contemplated that the actions illiterate by blocks 140 and 150 may be carried out irrespective of whether generalized data communication is possible or not. For example, these actions may be carried out before a device is authorized to transmit data over a network or, in another embodiment, on a frequency that is not used to general data communication.

Block 139 illustrates an embodiment, in which the mobile client device may receive a wireless signal from which the location of the transmitting device may be inferred. A specific embodiment of block 139 may involve a WLAN in which only a few nodes know their physical location. A neural network may be employed in order to infer the location of the mobile client device. It is contemplated that other forms of artificial intelligence or computation techniques may be used to infer the location of the mobile client device or the transmitting device. It is also contemplated that this is one specific example where block 139 may be used and that other examples exist.

Block 150 illustrates that the mobile client device may estimate its location utilizing, at least in part, the location of the transmitting device and the distance of the mobile client device from the transmitting device. Block 160 illustrates that blocks 120-150 may be repeated using a number of transmitting devices in order to increase the accuracy of the estimation. It is contemplated that the technique of triangulation may be employed to increase the accuracy of the location estimation.

Block 170 illustrates that once the physical location of the mobile client device has been estimated, it may be transmitted to other devices. In the specific example above, once the laptop has determined its location, it may transmit that location to a print server in order to print to the nearest printer. Or, it may act as a transmitting device to another mobile client device engaged in the actions illustrated in FIG. 1. It is contemplated that these are merely two non-limiting examples of why a mobile client deice may transmit its location to another device.

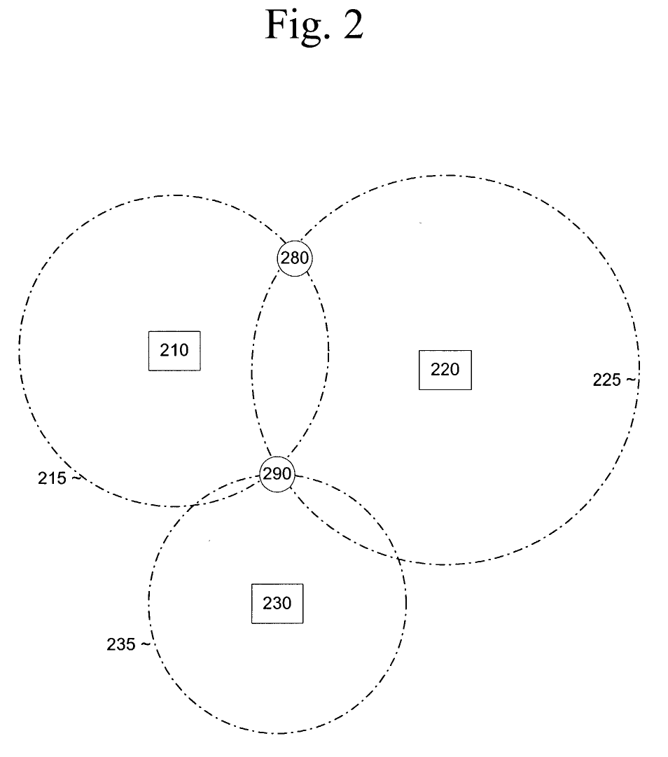

FIG. 2 is an embodiment of a system of the disclosed subject matter and illustrates how blocks 150 and 160 may be used to estimate the location of a mobile client device. A mobile client device, not shown in FIG. 2, may receive a wireless signal from transmitting device 210 of FIG. 2. After performing blocks 120-160, as shown on FIG. 1, the mobile client device is able to estimate is location within one dimension of accuracy. The mobile device may be able to determine that it is located at a point somewhere on radius 215, as shown on FIG. 2. The mobile client device may receive a second wireless signal from transmitting device 220. Regarding transmitting device 220 in isolation, the mobile client device may be able to determine that it is located at a point somewhere on radius 225. However, by utilizing the information gained from transmitting device 210, the mobile client device may increase the accuracy of its location estimation. The mobile client device may determine its location to within one of two points in two dimensions. The mobile client device may estimate that it is located at either point 280 or 290.

The mobile client device may receive a third wireless signal from transmitting device 230. By utilizing the location estimations derived from transmitting devices 210, 220, and 230, the mobile client device may increase the estimation of its location to one point, 290, in two dimensions. It is contemplated that, if a fourth transmitting device, which is not co-planer to the other three transmitting devices, is utilized, the mobile client device may estimate its location within three dimensions. It is contemplated that any number of transmitting devices may be utilized. It is further contemplated that the transmitting devices need not be a WLAN access point, a transmitting device may be any other WLAN node, including, for example, another WLAN mobile client device.

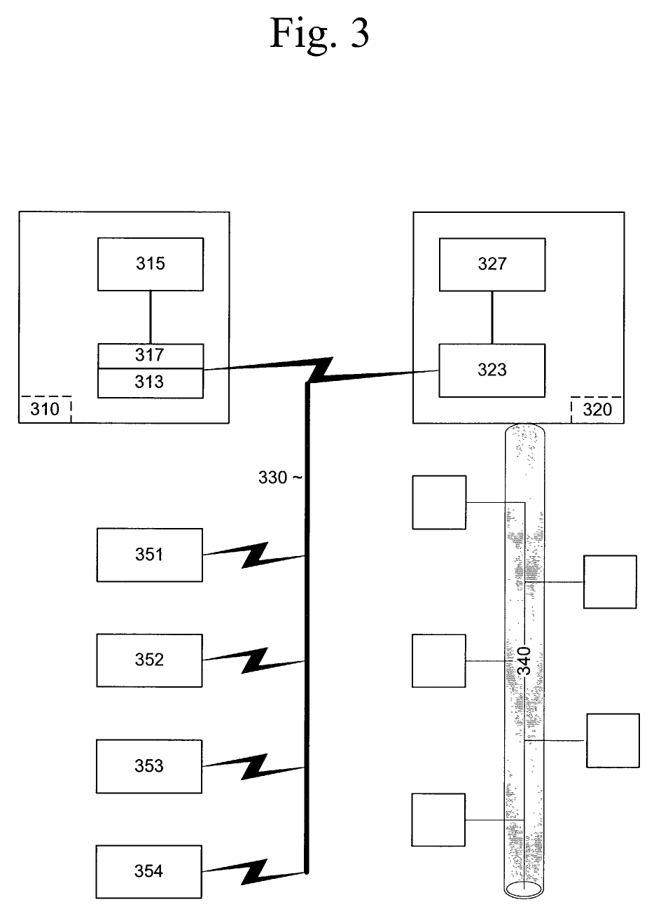

FIG. 3. illustrates an embodiment of the disclosed subject matter that includes a WLAN mobile client device 310. Mobile client device 310 may include a receiver 313, that is capable of establishing the mobile client device on a WLAN 330 and detecting the distance between the WLAN mobile client device and at least one transmitting device. It is contemplated that the transmitting devices need not be a WLAN access point, a transmitting device may be any other WLAN node, including, for example, another WLAN mobile client device. It is also contemplated that the receiver 313, may employ a variety of techniques, including those illustrated by FIG. 1, to detect the distance of the mobile client device from the transmitting device.

It is contemplated that receiver 313 may be arranged in order to improve reception of signals transmitted by device 310. In one embodiment, receiver 313 may be modified in such a manner in order to facilitate the distance measurement performed by location estimation system 317. However, it is contemplated that other uses for such a modification may occur in other embodiments. It is also contemplated that receiver 313 may be a directional, omni-directional, or a mixture thereof. It is contemplated that this determination need not be completely accurate and that an estimation of the distance within an acceptable degree of tolerance would be appropriate. It is further contemplated that this acceptable degree of tolerance would vary depending on the situation.

Mobile client device 310 may also include a location estimation system 315, which is capable of estimating the physical location of the mobile client device. Location estimation system 315 may estimate the location of the mobile client device utilizing the distance of the mobile client device from the transmitting device and the location of the physical device. It is contemplated that physical location of the transmitting device may be determined through a variety on techniques, such as, for example, those illustrated by FIG. 1. Location estimation system 315 may be capable of producing an estimation of the mobile client device's location that is accurate to one, two or three dimensions.

Mobile client device 310 may also include a transmitter 317, which is capable of transmitting the estimation of the mobile client device's location to other devices on the WLAN. It is contemplated that the elements of mobile device 310 may be ingrate as one, two or three discrete components. It is also contemplated that receiver 313 and transmitter 317 may include a physical layer (PHY) and a media access control (MAC) layer.

FIG. 3 also illustrates an embodiment of a system of the disclosed subject matter. Such a system includes mobile client device 310 and WLAN access point 320. WLAN access point 320 may include a memory element 327 to store information representing the physical location of access point 320. This information may be dynamically determined, such as, for example, via a component that receives information from the global positioning system (GPS), or a location estimation system similar to that used by mobile client device 310. It is contemplated that these are merely two illustrative examples of techniques to dynamically configure the location of WLAN access point 320 and that other techniques are possible. Alternatively, the location information may be statically configured and stored into memory element 327 upon installation of the access point. Once again, it is contemplated that this merely an illustrative example of a technique to statically configure the location of WLAN access point 320 and that other techniques are possible.

WLAN access point 320 may also include a transceiver 323, which is capable of transmitting the location of the WLAN access point to another node on WLAN 330. WLAN access point 320 may also be capable of transmitting information between WLAN 330 and a network 340. Examples of network 340 may include networks, such as, for example, the Internet or an intranet. While the illustrated embodiments of the disclosed subject matter deal mainly with access to the Internet, it is contemplated that various embodiments may be easily adapted to interface with a variety of networks and that the disclosed subject matter is not limited to any particular network. It is also contemplated that an access point may not be directly coupled to a network backbone; an access point may merely serve as a gateway to another network, which in turn provides access to a network backbone.

WLAN nodes 351-354 illustrates other transmitting devices which mobile client device 310 may use to increase the accuracy of a location estimation. It is contemplated that the transmitting devices 351-354 need not be a WLAN access point, a transmitting device may be any other WLAN node, including, for example, another WLAN mobile client device.

While certain features of the disclosed subject matter have been illustrated and described herein, many modifications, substitutions, changes, and equivalents will now occur to those skilled in the art. It is, therefore, to be understood that the appended claims are intended to cover all such modifications and changes that fall within the true spirit of the disclosed subject matter.

1. An apparatus comprising:
a transceiver to
detect the distance between the apparatus and at least one other device, and
facilitate the establishment of the apparatus on a wireless local area network (WLAN); and
a location estimation system to estimate the physical location of the apparatus utilizing, at least in part,
the distance between the apparatus and at least a first device, and
the physical location of the at least a first device.

2. The apparatus of claim 1, wherein the location estimation system, during operation, produces an estimation of the physical location of the apparatus in at least one dimension.

3. The apparatus of claim 2, wherein the location estimation system, during operation, produces an estimation of the physical location of the apparatus utilizing:
a plurality of respective distances between the apparatus and a plurality of devices; and
the physical location of at least one of the plurality of devices.

4. The apparatus of claim 3, wherein the location estimation system, during operation, produces an estimation of the physical location of the apparatus utilizing:
a plurality of devices; and
a neural network.

5. The apparatus of claim 2, wherein the transceiver, during operation, transmits a series of packets via a wireless signal to facilitate the detection of the distance between the apparatus and at least a first device.

6. The apparatus of claim 5, wherein the transceiver, during operation, transmits the series of packets irrespective of whether the apparatus is established on the WLAN.

7. The apparatus of claim 5, wherein the transceiver, during operation, transmits the series of packets simultaneously at multiple frequencies.

8. The apparatus of claim 7, wherein the transceiver, during operation, transmits the series of packets simultaneously at frequencies between 2 GHz and 5 GHz.

9. The apparatus of claim 5, wherein the transceiver, during operation, detects distance by measuring the strength of a received wireless signal.

10. The apparatus of claim 9, wherein the transceiver, during operation, at least partially adjusts the measurement of the strength of the received wireless signal to compensate for at least one of the following:
the reflection experienced by the wireless signal,
the refraction experienced by the wireless signal, and
the multiple transmissions paths experienced by the wireless signal.

11. The apparatus of claim 5, wherein the transceiver, during operation, detects the distance by measuring the time of flight of a received wireless signal.

12. The apparatus of claim 11, wherein the transceiver, during operation, measures the time of flight of the received wireless signal via at least one of the following:
correlating the phase change of the received wireless signal, at a given frequency, to distance,
correlating the delays between multiple codes transmitted by a plurality of devices participating in the location measurement, synchronously or asynchronously, for the purpose of location measurement,
correlating a phase change in a series of codes to the time of transmission, and
correlating a time of transmittal marker, received via the received wireless signal, to the time the received wireless signal arrived at the receiver.

13. The apparatus of claim 5, wherein the transceiver, during operation,
transmits a wireless signal;
receives the wireless signal; and
utilizes the received wireless signal to facilitate the measurement of the distance between the apparatus and the, at least a, first device.

14. The apparatus of claim 13, wherein the transceiver receives signals in a directional manner.

15. The apparatus of claim 14, wherein the apparatus comprises one of the following:
a laptop computer,
a handheld computer,
a personal digital assistant,
a wireless local area network (WLAN) interface card, and
a computer peripheral.

16. The apparatus of claim 15, wherein the transceiver, during operation, facilitates the establishment of the apparatus on a wireless local area network (WLAN) that utilizes a protocol selected from a group consisting essentially of:
a protocol substantially in compliance with any of the IEEE 802.11 family of specifications,
a protocol substantially in compliance with an ultra wide band protocol; and
a protocol substantially in compliance with the Bluetooth specification.

17. The apparatus of claim 5, wherein the transceiver, during operation, transmits the estimation of the physical location of the apparatus to at least one other device via a wireless signal.

18. The apparatus of claim 17, wherein the transceiver, during operation, transmits the detected distance between the apparatus and the at least one other device to the at least one other device via a wireless signal.

19. A system comprising:
a wireless local area network (WLAN) access point, including:
a memory element to store information representing the physical location of the WLAN access point, and
the capability to, during operation, transmit the information representing the physical location of the WLAN access point to a wireless local area network (WLAN) mobile client device; and
a wireless local area network (WLAN) mobile client device, including:
a transceiver to
detect the distance between the WLAN mobile client device and at least a wireless local area network (WLAN) device, and
facilitate the establishment of the WLAN mobile client device on a wireless local area network (WLAN); and
a location estimation system to estimate the physical location of the WLAN mobile client device utilizing, at least in part,
the distance between the WLAN mobile client device and the WLAN device, and
the physical location of the at least a first device.

20. The system of claim 19, wherein the wireless local area network (WLAN) access point dynamically determines the physical location of the wireless local area network (WLAN) access point.

21. The system of claim 19, wherein the physical location of the wireless local area network (WLAN) access point is remotely and statically configured and stored into the memory element.

22. The system of claim 19, wherein the location estimation system of the wireless local area network (WLAN) mobile client device, during operation, produces an estimation of the physical location of the WLAN mobile client device in at least one dimension.

23. The system of claim 22, wherein the location estimation system of the wireless local area network (WLAN) mobile client device, during operation, produces an estimation of the physical location of the WLAN mobile client device utilizing:
a plurality of respective distances between the WLAN mobile client device and a plurality of other WLAN devices; and
the physical location of at least one of the plurality of WLAN devices.

24. The system of claim 22, wherein the transceiver of the WLAN mobile client device, during operation, transmits a series of packets via a wireless signal to facilitate the detection of the distance between the WLAN mobile client device and at least one other WLAN device.

25. The system of claim 24, wherein the transceiver of the wireless local area network (WLAN) mobile client device is capable of, during operation, determining the distance utilizing, at least in part, a measurement of the strength of wireless signal received from the at least one other device.

26. The system of claim 25, wherein the transceiver of the wireless local area network (WLAN) mobile client device is capable of, during operation, adjusting the measurement of the strength of the received wireless signal due to at least one of the following:
the reflection possibly experienced by the wireless signal,
the refraction possibly experienced by the wireless signal, and
the multiple transmissions paths possibly experienced by the wireless signal.

27. The system of claim 24, wherein the transceiver of the wireless local area network (WLAN) mobile client device is capable of, during operation, determining the distance utilizing, at least in part, a measurement of the flight time of wireless signal received from the at least one other device.

28. The system of claim 27, wherein the transceiver of the wireless local area network (WLAN) mobile client device is capable of, during operation, measuring of the flight time of wireless signal received from the at least one other device utilizing, at least in part, techniques selected from a group consisting essentially of:
correlating the phase change of the received wireless signal, at a given frequency, to distance,
correlating a phase change in a series of codes to the time of transmission, and
correlating a time of transmittal marker, received via the received wireless signal, to the time the received wireless signal arrived at the receiver.

29. The system of claim 24, wherein the wireless local area network (WLAN) mobile client device comprises one of the following:
a laptop computer,
a handheld computer,
a personal digital assistant,
a wireless local area network (WLAN) interface card, and
a computer peripheral.

30. The system of claim 29, wherein the WLAN access point and the WLAN mobile client device, during operation, communicate utilizing a protocol selected from a group consisting essentially of:
a protocol substantially in compliance with any of the IEEE 802.11 family of specifications,
a protocol substantially in compliance with an ultra wide band protocol; and
a protocol substantially in compliance with the Bluetooth specification.

31. A method comprising:
establishing a mobile client device on a wireless local area network (WLAN);
receiving a wireless signal from a first transmitting device;
determining the distance between the mobile client device and the first transmitting device;
utilizing a received wireless signal to, at least, infer the physical location of the first transmitting device;
estimating the physical location of the mobile client device.

32. The method of claim 31, wherein estimating the physical location of the mobile client device includes estimating the physical location in at least one dimension.

33. The method of claim 32, wherein estimating the physical location includes utilizing:
determining the distance between the mobile client device and a plurality of transmitting devices; and
utilizing the physical location of at least one of the plurality of transmitting devices.

34. The method of claim 33, wherein estimating the physical location of the mobile client device includes utilizing:
a plurality of devices; and
a neural network.

35. The method of claim 32, further including transmitting a series of packets via a wireless signal to facilitate determining the distance between the mobile client device and the first transmitting device.

36. The method of claim 35, wherein transmitting a series of packets via a wireless signal includes transmitting the series of packets simultaneously at multiple frequencies.

37. The method of claim 36, wherein transmitting the series of packets simultaneously at multiple frequencies includes transmitting between 2 GHz and 5 GHz.

38. The method of claim 35, wherein determining the distance between the mobile client device and the first transmitting device includes determining the distance by measuring the strength of a received wireless signal.

39. The method of claim 38, wherein determining the distance includes at least partially adjusting the measurement of the strength of the received wireless signal to compensate for at least one of the following:
the reflection experienced by the wireless signal,
the refraction experienced by the wireless signal, and
the multiple transmissions paths experienced by the wireless signal.

40. The method of claim 35, wherein determining the distance includes detecting the distance by measuring the time of flight of a received wireless signal.

41. The method of claim 40, wherein determining the distance includes measuring the time of flight of the received wireless signal via at least one of the following:
correlating the phase change of the received wireless signal, at a given frequency, to distance,
correlating a phase change in a series of codes to the time of transmission, and
correlating a time of transmittal marker, received via the received wireless signal, to the time the received wireless signal arrived at the receiver.

42. The method of claim 35, further including
transmitting a wireless signal;
receiving the wireless signal; and
utilizing the received wireless signal to facilitate determining the distance between the mobile client device and the first transmitting device.

43. The method of claim 42, wherein receiving a wireless signal from a first transmitting device includes receiving a wireless signal in a directional manner.

44. The method of claim 42, wherein establishing a mobile client device on a wireless local area network (WLAN) includes utilizing a protocol selected from a group consisting essentially of:
a protocol substantially in compliance with any of the IEEE 802.11 family of specifications,
a protocol substantially in compliance with an ultra wide band protocol; and
a protocol substantially in compliance with the Bluetooth specification.

45. The method of claim 35, further including transmitting an estimation of the physical location of the mobile client device to at least one first transmitting device via a wireless signal.

46. The method of claim 45, further including transmitting the detected distance between the mobile client device and the at least one other device to the at least one other device via a wireless signal.

47. An article comprising:
a storage medium having a plurality of machine accessible instructions, wherein when the instructions are executed by a processor, the instructions provide for
receiving a wireless signal from a first transmitting device;
determining the distance between the mobile client device and the first transmitting device;
utilizing a received wireless signal to, at least, infer the physical location of the first transmitting device;
estimating the physical location of the mobile client device.
